(19) United States
(12) Patent Application Publication
(10) Pub. No.: US 2014/0082157 A1
(43) Pub. Date: Mar. 20, 2014

(54) SYSTEM AND METHOD FOR SELECTIVELY PERMITTING ENTRY INTO A DEFINED MODE BY DISTRIBUTED CLIENT-SIDE SOFTWARE APPLICATIONS

(71) Applicant: ARTISAN MOBILE, INC., Philadelphia, PA (US)

(72) Inventors: Michael S. RABER, West Chester, PA (US); Daniel E. KOCH, Philadelphia, PA (US)

(73) Assignee: Artisan Mobile, Inc., Philadelphia, PA (US)

(21) Appl. No.: 13/798,713

(22) Filed: Mar. 13, 2013

Related U.S. Application Data
(60) Provisional application No. 61/702,531, filed on Sep. 18, 2012.
(60) Provisional application No. 61/705,097, filed on Sep. 24, 2012.

(51) Int. Cl. H04L 12/24

(52) U.S. Cl. CPC H04L 41/0803
USPC 709/220

(57) ABSTRACT

A system and method for permitting entry into a defined operational mode of a software application on a selective basis. To enter the limited-access mode, action must be taken at both a server and a client device. The client device stores a software application that is configured with inactive functionality for entering the predefined mode in response to user input. The server is operable to provide very limited distribution of configuration settings data to activate the functionality for recognizing predefined user input and responsively entering the predefined mode. The required predefined user input is a widely-kept secret to which access is extremely limited, and is identified to users only an as-needed basis. Accordingly, access to the defined mode is limited to users (i) having a computing device that has received the configuration settings data enabling recognition of the predefined user input, and (ii) knowing and providing the predefined user input.

### CROSS-REFERENCE TO RELATED APPLICATIONS

This application claims the benefit of priority under 35 U.S.C. 119(e) of U.S. Provisional Patent Application No. 61/702,531, filed Sep. 18, 2012, and U.S. Provisional Patent Application No. 61/705,097, filed Sep. 24, 2012, the entire disclosures of both of which are hereby incorporated herein by reference.

### FIELD OF THE INVENTION

The present invention relates generally to management of software applications for smartphones and other mobile computing devices, and more particularly to a system and method for selectively permitting entry into a defined operational mode by distributed client-side software applications.

### DISCUSSION OF RELATED ART

Client/server application developers develop software applications that are deployed on distributed computing devices that communicate, e.g., via the internet or other communications networks, with a centralized server during normal operation. In the context of smartphone-type computing devices operating within cellular or other wireless communications networks, software applications are typically deployed to individual computing devices by downloading of the applications to each device asynchronously, for example, by each user's downloading of the application from an application server of an “app store.”

After downloading the application to the user's device, the user may operate the device and interact with the application as desired. For the most part, the user's operation of the device/application may be performed independently, though such operation may involve network communication with the app store's application server, or a back-end server associated with the software application.

In certain limited circumstances, it may be necessary or desirable for the software application to enter a pre-defined operational mode of the device to which access is typically limited. This may involve, for example, entry into a debugging mode for debugging purposes, or entry into a logging mode for data logging purposes, or entry into a special operational mode having enhanced or limited functionality. This typically involves exercise of centralized control from the server side of the network. For example, a developer may wish to turn off a certain portion of a specific application's functionality to avoid application/device crashes reported by one of the application's users. Alternatively, a developer may wish to place a device into a debugging or edit mode in which certain additional interactions between the client and server devices are permitting for debugging or other purposes.

Unfortunately, most existing techniques permit such entry only on a universal level applicable to all distributed software applications or require to know something specific about the user on the specific device like the logged-in user's userId. Because such information is generally unknown, to turn off a portion of a specific application's functionality, the developer must generally turn off that portion of that application on all users' client devices universally. Accordingly, the developer has no control for selectively permitting entry into a limited-access defined operational mode by distributed client-side software applications, such that the functionality could be disabled only a single user's device.

Generally, such existing techniques involve the developer's use of a development computing device 40 (such as a personal, general purpose computer configured for this purpose) to configure a back-end server 100 (such as a general purposes server computer configured to act as a back-end server) to propagate a configuration setting that will place an associated computing device into the desired mode once the configuration setting has been received, as shown in FIG. 1. All devices (20a, 20b, 20c, 20d) running the app will receive the configuration setting at an appropriate time, which generally involves communicating with the back-end server 100 at start-up, at certain breakpoints, upon reboot, at certain time intervals, on particular screens, etc. Accordingly, although it may not happen simultaneously for all users/devices, each user/device will generally get the configuration setting during the normal course of use of the application.

Approaches that are universally-applicable to all client computing devices have certain disadvantages. By way of example, such approaches can be overly burdensome to networks or devices, which is particularly undesirable all but the single device with which it may be necessary to interact. Additionally, debugging in this context often involves logging of data, and logging of data for all devices, rather than the intended device, is overly burdensome to the back-end server or other systems.

Other techniques provide control on a targeted level, e.g., for a single device, but are also undesirable. For example, one targeted approach for putting a single device into a desired debugging or other mode is to program the application such that in displays via the applications graphical user interface a button or other user-operable switch that allows the user to take action to manually place the application into the desired mode. However, such an approach is undesirable in that it requires fairly sophisticated user involvement and/or requires that the user be made aware of such functionality. Further, it provides the user with absolute control over whether to the enter the mode. In embodiments in which the placement of a device in this mode increases a load or burden on a network and/or the back-end system, the network or back-end system could be easily overloaded if too many users initiated this mode concurrently.

Another technique providing control on a targeted level involves designing the application and/or back end server such that the user can log in to the back and server and initiate the propagation of configuration settings to the specific user's device/account associated with the login information. However, this approach is undesirable in that it too provides the user with absolute control over whether to the initiate the mode, and could lead to overloading of the network or back-end system.

Yet another technique providing control on a targeted level involves designing the application such that it is aware of a unique device ID (UDID or mac address), and designing the back-end server such that configuration settings may be propagated only to the specific phone having that unique device ID. However, this approach is undesirable in that it too provides the user with absolute control over whether to the initiate the mode, and could lead to overloading of the network or back-end system. Further, this approach is undesirable in that the backend system needs to know of the list of unique device IDs. This requires the collection of unique device ID from the end user, which might be difficult to acquire depending the on app, platform, or type of user.

What is needed is a system and method for selective server-side control of distributed client-side software applications that allows a client-side application to be placed in a debugging or other selected mode in a manner that permits server-side control, does not overly burden the user, and does not provide the user with absolute control over initiating the mode such that network and/or back-end systems could be overloaded.

### SUMMARY

The present invention provides a system and method for selectively permitting entry into a defined operational mode, e.g., by just a single instance of a software application at a single client computing device. To enter the predefined operational mode, action must be taken both at a centralized server, and at the client computing device. The method involves installation on the client computing device of a software application that is configured with inactive functionality for entering the predefined mode in response to user input. The method further involves very limited distribution of configuration settings data to activate the functionality for recognizing predefined user input and responsively entering the predefined mode. Further, the method involves maintaining the required predefined user input as a widely-kept secret to which access is extremely limited, and identifying the predefined user input required to users only an as-needed basis. Accordingly, access to the defined mode is limited to users (i) having a computing device that has received the configuration settings data enabling recognition of the predefined user input, and (ii) knowing and providing the predefined user input.

### BRIEF DESCRIPTION OF THE FIGURES

An understanding of the following description will be facilitated by reference to the attached drawings, in which:

FIG. 1 is a system diagram showing an exemplary network computing environment in which the present invention may be employed;

FIG. 2 is a flow diagram illustrating an exemplary method for selective server-side control of distributed software applications;

FIG. 3 is a schematic diagram of an exemplary system for selectively permitting entry into a limited-access defined operational mode by distributed client-side software applications in accordance with an exemplary embodiment of the present invention;

FIG. 4 is a schematic diagram of an exemplary application server storing a specially-configured application capable of permitting entry into a limited-access defined operational mode in accordance with an exemplary embodiment of the present invention; and

FIG. 5 is a schematic diagram of an exemplary client computing device storing an application in accordance with an exemplary embodiment of the present invention.

### DETAILED DESCRIPTION

The present invention relates to a system and method for selectively permitting entry into a defined operational mode by distributed client-side software applications, e.g., to provide selective server-side control of distributed client-side software applications that allows a selected client-side application on a single client device to be selectively placed in a debugging or other mode in a targeted manner, without placing all other distributed instances of the application in the debugging mode, and/or without overly burdening the user, and/or without providing the user with absolute control over initiating the mode such that network and/or back-end systems could be overloaded.

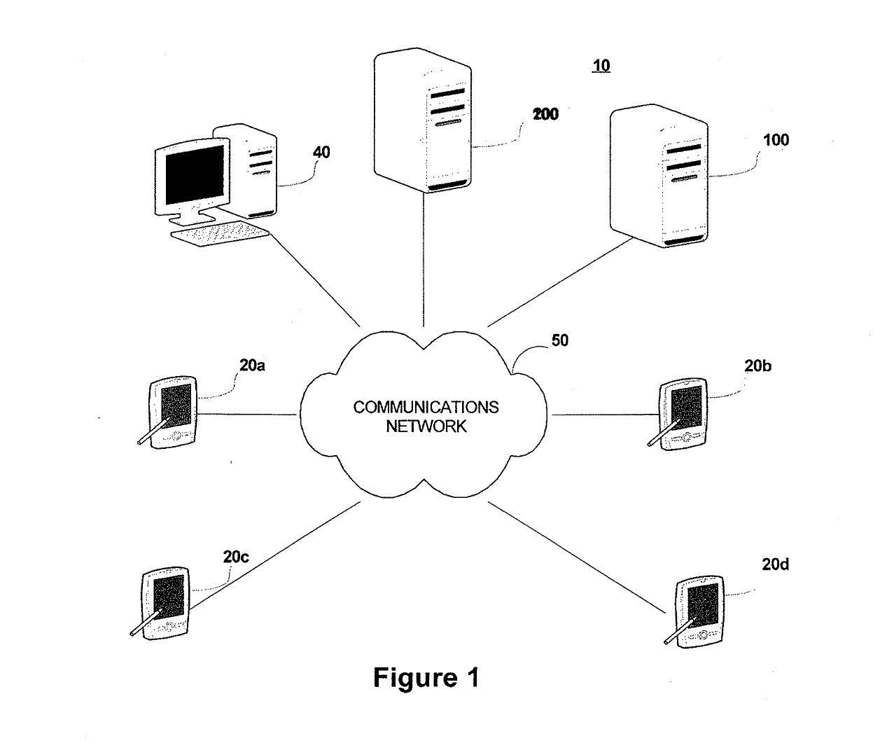

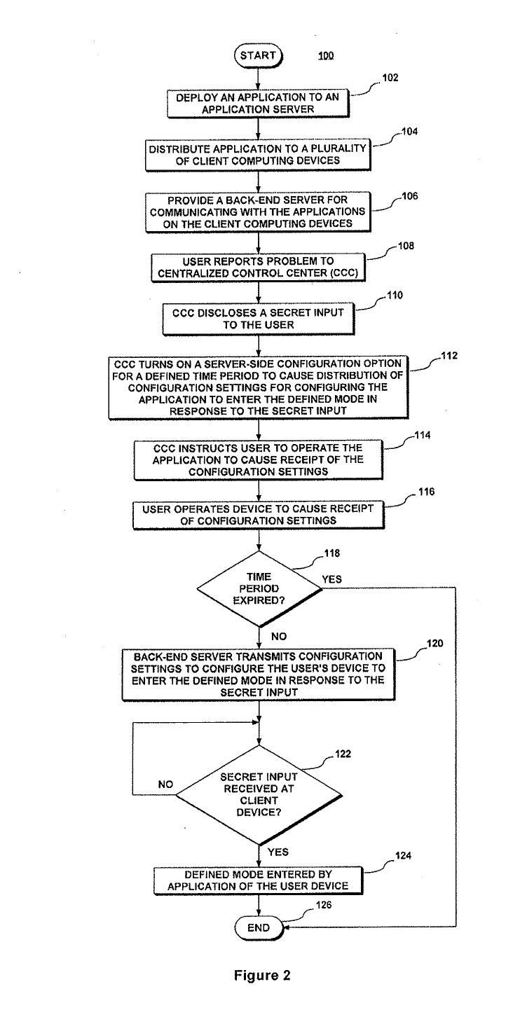

Referring now to FIG. 2, a flow diagram 100 is shown illustrating an exemplary method for selectively permitting entry into a defined operational mode by distributed client-side software applications that may be implemented in the exemplary network computing environment 10 of FIG. 1. Referring now to FIGS. 1 and 2, the exemplary method begins with deployment of a software application to an application server 100, as shown at 102. The deployment may be performed in a conventional manner, and may involve, for example, transmitting a production-ready version of the application to an operator of a web-based “app store” for subsequent distribution by an application server of an app store. By way of example, this may involve transmission of a deployment-ready application from a developer station 40 to an application server 100 via the communications network 50 shown in FIG. 1. Preferably, the application is specially-configured in accordance with the present invention in that it is configured to be selectively placed in the defined operational mode only after receipt from a back-end server of configuration settings that selectively turn on certain functionality.

Referring again to FIGS. 1 and 2, the method involves distributing the application to a plurality of client computing devices 20a, 20b, 20c, 20d, as shown at 104. By way of example, a client computing device may be a smartphone such as in iPhone, a tablet PC such as an iPad, or any other network-connected mobile computing device. The distribution may be performed in a conventional manner. By way of example, such distribution may involve a user's operation of his/her client computing device, e.g., 20a, to communicate via a communications network 40, such as a Verizon, Cingular, Sprint, T-Mobile or other wireless telephone network, to communication with a network-connected application server 100 supporting a network-based application store, such as Apple's AppStore, and initiating downloading of the application in a conventional manner.

Referring again to FIGS. 1 and 2, the method further involves providing a back-end server 100 for communicating with the applications on the client computing devices 20a, 20b, 20c, 20d. It will be appreciated by those skilled in the art that it is commonplace for a vendor/distributor of a software application to maintain a back-end server for communicating with and supporting an associated software application. The back-end server may be largely conventional in that it may include general purpose computing hardware and software. However, the back-end server 100 in the present example is specially-configured in accordance with the present invention to include and provide configuration setting data for configuring an associated application to enter a pre-defined operational mode in response to certain user input at the user device.

The defined mode may be any suitable mode other than the usual mode of operation, to which access is typically limited. By way of example, the defined mode may be a debugging mode for debugging purposes, or a logging mode for data logging purposes, or a special operational mode having enhanced or limited functionality.

Information for transmitting the configuration setting data may be stored at the back-end server 100, and the configuration setting data may be transmitted to the client device, e.g., 20a, in any suitable manner and/or format. By way of example, the configuration setting data may be transmitted to the applications in the form of a Boolean value for a specific key/value pair. For example, the application may have a predetermined value of 0 for a specific named key corresponding to an input mode in which certain user input would not be recognized, and the configuration setting data may provide a predetermined value of 1 for that named key, corresponding to an input mode n which the same certain user input would be recognized, and would cause the application to enter the defined mode. Alternatively, for example, the configuration setting data may provided additional information. For example, any value greater than 0 might be used to indicate the number of minutes for which the input mode should recognize the certain user input. By way of further alternative example, the configuration setting data could call a specific URL/endpoint on the back-end server that either responds by just returning the Boolean/other value, or receives a variable name as a parameter, looks up the value, and returns the value back to the client computing device. Any suitable approach may be used to deliver configuration setting data that will selectively “turn on” an input mode in which certain predefined user input will be recognized and responsively permit entry of the client computing device into the pre-defined limited-access operational mode.

The user input required to cause the client computing device to enter the predefined limited-access operational mode is preferably maintained as a secret, in that it is not generally disclosed to a user of the application, or to the public at large, but rather is disclosed selectively only on an as-needed basis, as discussed below. By way of example, the secret input is pre-defined and is preferably input that is unlikely to be used in other contexts, or to be provided accidentally. By way of example, the secret input could be a specific gesture provided as input to a touch-screen, such as a symbol, figure or multi-finger swipe, a series of button selections, a series of finger-taps, an alphanumeric code entered via a keyboard input of the device, etc. Any desired input may be used.

Further, the back-end server 100 is specially-configured with a user-operable switch to selectively toggle the back-end server between a first mode in which such configuration setting data will not be distributed to client computing devices, and a second mode in which such configuration setting data will be distributed to client computing devices. By way of example, the switch may be accessible as a control within a user interface operable by a customer service representative, developer or other authorized individual within a centralized control center, such as a customer service center, a software development center, or the like. By way of example, the user interface may be accessible via a developer's or customer service representative's workstation 40 that is connected to communications network 50 and in communication with back-end server 100.

After a period of operation of the application by one or more users on one or more client computing devices, a single user may report a problem to the centralized control center (CCC), as shown at step 108. This report may be made, for example, via e-mail, a chat session, a telephone call, etc. to a representative of the CCC, such as a customer service representative, help desk member, software developer, etc. If the representative chooses to place the reporting user's device into a special mode, e.g. for debugging purposes, the user will disclose the secret input to the user, as shown at 110. By way of example, the secret may be disclosed to the user via e-mail, a chat session, a telephone call, etc.

It should be noted that at this point the user knows the secret input, but cannot initiate the special mode of the application, because the application is not yet configured to enter the special mode because it has not yet been configured with the configuration settings causing the application to enter the special mode in response to the secret input. Accordingly, the user does not have absolute control over initiation of the special mode. Rather, further actions must be taken on the part of the CCC, as discussed below.

Next, the CCC representative turns on a server-side configuration option for a defined time period, as shown at 112. This option may be turned on using the user interface switch described above with reference to step 106. The server-side configuration option permits distribution of the configuration settings for configuring the application to enter the defined mode in response to the secret input. The defined time period is very limited relative to the length of time for which the application is, will be, or has been operable. The defined period is preferably limited to the short period of time that will be necessarily for only the single user communicating with the CCC to take certain actions to initiate download of the configuration settings to that single user's computing device. Accordingly, for example, a certain version of an application may have a useful life of 6 months-5 years, and yet the defined period may be less than 10 minutes, or 5 minutes, or 1 minute, or 30 seconds.

Alternatively, the retrieval of the configuration settings could be limited by factors other than time, such as IP addresses or geo-location of the client computing device. This would also limit the number of users who were permitted to retrieve the settings. More specifically, the back-end server 100 may be configured to permit download of the configuration settings by a requesting client device only if the device's IP address or geo-location (determined by conventional techniques) matches or falls within a range or otherwise complies with a rule for permitting such downloading that is intended to generally restrict download from all requesting devices and yet to permit download by the intended target device.

In this example, the CCC next instructs the user to operate the user's device and/or application to cause receipt of the configuration settings, as shown at 114. By way of example, this may involve the representative providing instructions to the user via e-mail, a chat session, a telephone call, etc. As will be appreciated by those skilled in the art, certain routine activities involved in operation of such a client software application will routinely initiate communication with an associated back-end server and cause transmission from the back-end server to the requesting client device any application configuration settings, e.g., along with any other requested resources or data. By way of example, this may involve instructing the user to close and then re-open/re-execute the application, or to move an open application into the background of an operating system environment, and then into the foreground.

Such actions routinely result in the application's execution in accordance with the latest configuration settings available at the background server. However, in accordance with the present invention, downloading of configuration settings that will configure the application such that it will recognize pre-defined user input (the secret user input), and in response thereto cause the application to enter the predefined mode.

Accordingly, as shown at 118, if the time period has expired, the user will not receive the configuration settings enabling entry of the defined mode in response to input of the secret input. In this example, the method ends. From another perspective and/or in other embodiments, operation of the application will simply continue as usual, and the application/device will not be responsive to the secret input. Accordingly, even if the “secret” input were to become widely known by many users, such users would not have absolute control over initiation of the defined mode, because such users' applications would generally lack the configuration settings for enabling the application to enter the defined mode in response to the secret input.

If however, the time period has not expired, then the back-end server 100 transmits the configuration settings to configure the user's application to enter the defined mode in response to the secret input, in response to the user's operation of the device to cause receipt of the configuration settings, as shown at steps 118 and 120.

It should be noted that the requesting user may not be the only user whose device/application will receive the configuration settings during the defined time period. More specifically, any application of any user that requests configuration settings from the back-end server, e.g. during normal opening, foregrounding, etc. of the application, during the period that the back-end server is exposing the configuration settings for download will receive the configuration settings for causing the application to enter the defined mode in response to the secret input. However, such other users will not have absolute control over initiation of the defined mode if the have the configuration settings alone, because such users will generally not have the secret input, and in fact will likely be unaware that there is any secret input that could initiate a defined mode. The number of distinct users/applications that could receive the configuration settings is limited, due to the limited amount of time that the back-end server will permit download of the configuration settings.

Optionally, the back-end server 100 may be configured to permit download of the configuration settings a limited number of times, e.g., once, or no more than 20, 50, or 100 times, to limit the number of users that could receive the configuration settings. In such an embodiment, if the user in contact with the CCC did not receive the configuration settings, another period of time for downloading of the configuration settings could be initiated.

Alternatively, the back-end server 100 may be configured to permit only a single device to enter the defined mode, e.g., after permitting entry into a defined mode requiring a log in, and after a device has logged in. In such an embodiment, after a first log in (in response to a single instance of this method), the back-end server may be configured to stop distributing the configuration settings.

In the exemplary embodiment, the user then provides the secret input to the application at the client device. As mentioned above, this could involve providing pre-defined user input in the form of single or multi-finger gesture, providing an alphanumeric code, etc. In one embodiment, the configuration settings may add functionality (or more precisely enable latent, inactive functionality) for recognizing the secret, pre-defined input to every page/user interface screen of the application. In another embodiment, the configuration settings may add functionality for recognizing the secret, pre-defined input to only a single page/user interface screen of the application—in which case the user must not only provide the right secret input, but must also provide it after navigating to an appropriate user interface screen.

In certain embodiments, the particular secret input may be changed over time, as would be reflected in the configuration settings and the instructions provided by the CCC representative. Further still, the page/user interface screen that will accept that input may be changed over time. As will be appreciated by those skilled in the art, these techniques can be used to limit unauthorized and/or unintended entry into the defined mode by more than the intended users, e.g., in the event that a user published a secret code.

It should be noted that the secret input may be a single input at a single user interface screen, may involve multiple sequential inputs at a single user interface screen, or may involve multiple sequential inputs across several different user interface screens. In one embodiment, a visual indicator is displayed after a first input to indicate that the first input has been received and accepted and/or to prompt the user to provide a second/next sequential input. For example, the configuration settings may provide that in response to a first input (e.g., touching a certain screen for 2 seconds), that an icon or other visual indicator will be displayed, and that after display of the visual indicator a second input (e.g., a swipe in a defined pattern) must be provided before the defined mode can be entered.

In this example, if the secret input is received at the client device at 122, then the defined mode is entered by the application of the user device, as shown at 124. This may involve exercise of control from the server side of the system, e.g., the CCC, e.g., for logging or other troubleshooting purposes. By way of example, the defined mode may be designed to last for a certain predefined period of time or otherwise terminate in a defined fashion, or may be configured to be turned off from the server side. By way of example, the defined mode may be a debugging mode, an information logging mode, or an operational mode providing enhanced or limited functionality. By way of further example, the defined mode may involve presentation of an otherwise inaccessible login screen by which the user may login to the back-end server 100 to perform certain testing, analytical, configuration or other steps.

If, however, the secret input is not received at the client device, normal operation of the application continues until the secret input has been provided, as shown in FIG. 2. In certain embodiments, the user is provided with an opportunity to enter the secret input only until the predefined period of time has expired.

It should be noted that in other embodiments, the BES may be configured such that the user of the client computing device could initiate turning on of the switch at the BES, to cause distribution of the configuration settings. For example, the BES may be configured such that the user's navigation to a predefined web page (e.g., a login page of a particular web page) may turn on the switch such that the configuration settings will be distributed. Further, it should be appreciated that in other embodiments the application may be configured to programmatically contact the BES and turn on the configuration settings, e.g., after experiencing certain crashes, errors, problems, etc. to turn on a logging feature, etc. In such embodiments, an operator at the CCC need not be involved as described in the example above.

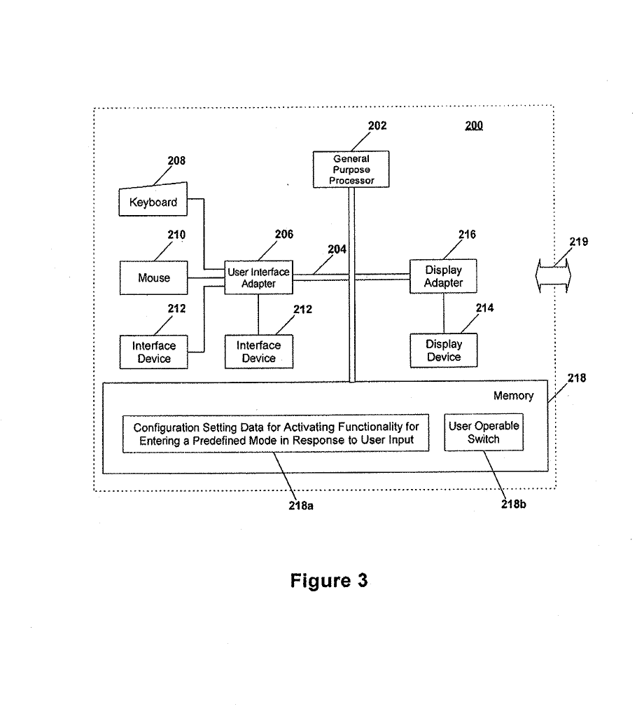

FIG. 3 is a block diagram of a back-end server system (BES) (shown logically as a single representative server for ease of illustration) 200 in accordance with the present invention. The BES 200 includes conventional computer hardware storing and/or executing specially-configured computer software that configures the hardware as a particular special-purpose machine having various specially-configured functional sub-components that collectively carry out methods in accordance with the present invention. Accordingly, the BES 200 of FIG. 3 includes a general purpose processor and a bus 204 employed to connect and enable communication between the processor 202 and the components of the BES 200 in accordance with known techniques. The BES 200 typically includes a user interface adapter 206, which connects the processor 202 via the bus 204 to one or more interface devices, such as a keyboard 208, mouse 210, and/or other interface devices 212, which can be any user interface device, such as a touch sensitive screen, digitized entry pad, etc. The bus 204 also connects a display device 214, such as an LCD screen or monitor, to the processor 202 via a display adapter 216. The bus 204 also connects the processor 202 to memory 218, which can include a hard drive, diskette drive, tape drive, etc.

The BES 200 may communicate with other computers or networks of computers, for example via a communications channel, network card or modem 219. The BES 200 may be associated with such other computers in a local area network (LAN) or a wide area network (WAN), and operates as a server in a client/server arrangement with another computer, etc. Such configurations, as well as the appropriate communications hardware and software, are known in the art.

The BES' software is specially configured in accordance with the present invention. Accordingly, as shown in FIG. 3, the BES 200 includes computer-readable, processor-executable instructions stored in the memory for carrying out the methods described herein. Further, the memory stores certain data, e.g. in databases or other data stores shown logically in FIG. 3 for illustrative purposes, without regard to any particular embodiment in one or more hardware or software components. For example, FIG. 3 shows schematically storage of configuration setting data 218a, and microprocessor-executable instructions for providing the user-operable switch (e.g., a user interface control) 218b for selectively toggling be BES 200 between the first and second modes, i.e., to turn on and off distribution of the configuration settings, in the memory 218 of the BES 200.

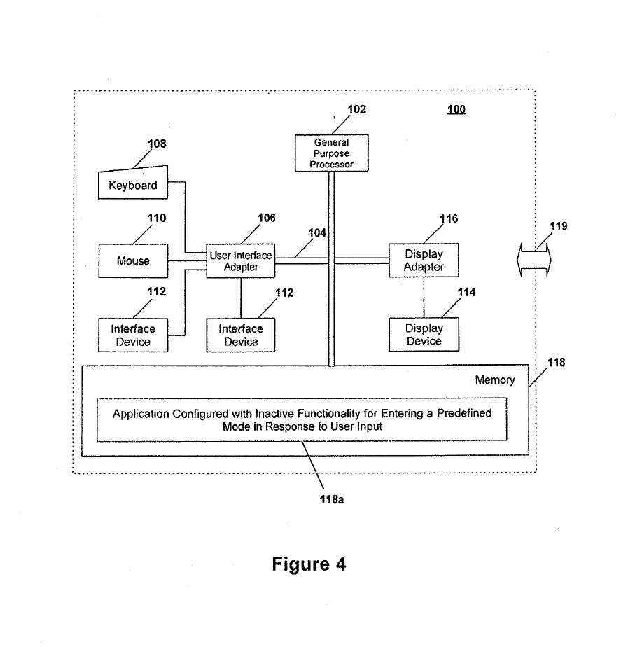

FIG. 4 is a block diagram of an exemplary application server (shown logically as a single representative server for ease of illustration) 100 in accordance with the present invention. The application server 100 includes conventional computer hardware storing and/or executing specially-configured computer software that configures the hardware as a particular special-purpose machine having various specially-configured functional sub-components that collectively carry out methods in accordance with the present invention. Further, the application server stores in its memory a specially-configured software application configured with inactive functionality for entering a predefined mode in response to user input. More specifically, the application is configured to receive configuration setting data from the BES that will activate an input mode that will permit entry of the defined mode in response to specific pre-defined user input, which is generally kept as a secret.

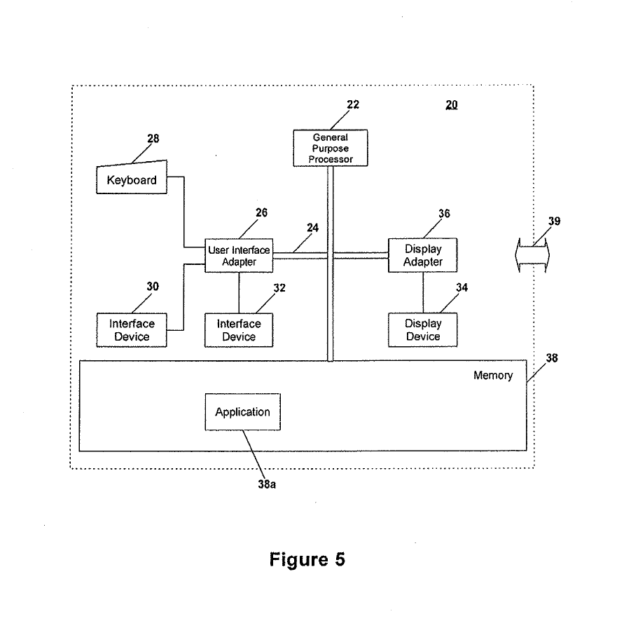

FIG. 5 is a block diagram of an exemplary client computing device, e.g., 20a, in accordance with the present invention. The client computing device 20 includes conventional computer hardware storing and/or executing specially-configured computer software that configures the hardware as a particular special-purpose machine having various specially-configured functional sub-components that collectively carry out methods in accordance with the present invention. Further, the client computing devices stores in its memory a specially-configured software application that is capable of entering a predefined mode in response to user input. Functionality for entering the predefined mode may be inactive, if the configuration setting data has not yet been received and/or stored in the memory of the client computing device, or may be active, if the configuration setting data has already been received and/or stored in the memory of the client computing device.

Further, the memory stores certain data, e.g. in databases or other data stores shown logically in FIG. 3 for illustrative purposes, without regard to any particular embodiment in one or more hardware or software components. For example, FIG. 3 shows schematically storage of configuration setting data 218a, and microprocessor-executable instructions for providing the user-operable switch (e.g., a user interface control) 218b for selectively toggling be BES 200 between the first and second modes, i.e., to turn on and off distribution of the configuration settings, in the memory 218 of the BES 200.

Accordingly, it will be appreciated that the system and method herein described do not provide absolute control over entry into the defined mode to the user, but rather require actions on the parts of both the user on the client side and a CCC representative on the server/system side, and thus avoids overloading of network and/or back-end systems. Further, the system and method does so in a manner that does not overly burden the user. Further still, the system does not need information unique to a user/device/app, such as a user ID, UIDD, or mac address, and yet permits entry of that device into the defined mode. Further, the CCC has centralized control over when the defined mode may be turned on. Further, while the defined mode is turned off, the application functions normally, and even the possibility of entering a defined mode is hidden from the user; i.e., there are no visible user-operable switches for turning on or off the defined mode.

A computer program product stored on a tangible computer-readable medium for carrying out the methods identified above is provided also. The computer program product comprises computer readable instructions for carrying out the methods described herein. In one embodiment, an exemplary computer program product comprises a tangible computer-readable medium storing a software application comprising a first instruction set for causing a computing device to provide primary application functionality, and a second instruction for causing the computing device to provide access to a defined operational mode only after receipt of configuration settings from a back-end server, the configuration settings configuring the software application to enter the defined operational mode in response to receipt of predefined user input via an input device of the computing device.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A method for selectively permitting entry into a limited-access defined operational mode by distributed client-side software applications, the method comprising:
deploying a software application to an application server, the application being configured to provide access to a defined operational mode only after receipt of configuration settings from a back-end server, the configuration settings configuring the application to enter the defined operational mode in response to receipt of predefined user input;
configuring the back-end server to provide limited distribution of the configuration settings;
instructing a specific user to operate the user's client computing device to cause transmission of the configuration settings to the user's client device;
in response to a request from the user's client device, transmitting the configuration settings from the back-end server to the user's client device via a communications network;
disclosing to the user the predefined user input required to cause the software application resident at the client device to enter the defined operational mode; and
receiving information from the user's client device after the application has entered the defined operational mode in response to the user's input of the predefined user input at the user's client device.

2. The method of claim 2, further comprising installing the application on the client device.

3. The method of claim 3, wherein the application is configured with inactive functionality for entering the predefined mode in response to user input, the configuration settings being operable when received at the client device to render active the formerly inactive functionality of the application.

4. The method of claim 3, wherein the application is configured to provide access to a defined operational mode providing additional application functionality.

5. The method of claim 3, wherein the application is configured to provide access to a defined operational mode providing limited application functionality.

6. The method of claim 3, wherein the application is configured to provide access to a defined operational mode providing application debugging functionality.

7. The method of claim 2, further comprising providing the back-end server.

8. The method of claim 1, wherein transmitting the configuration settings from the back-end server to the user's client device comprises transmitting a Boolean value for a predetermined key/value pair.

9. The method of claim 1, wherein transmitting the configuration settings from the back-end server to the user's client device comprises transmitting data causing call of a specific endpoint on the back-end server.

10. The method of claim 1, wherein disclosing to the user the predefined user input comprises disclosing one of a touch-screen input, a series of button inputs, a keyboard input.

11. The method of claim 1, wherein configuring the back-end server to provide limited distribution of the configuration settings comprises toggling the back-end server from a first mode in which such configuration data will not be distributed to client computing devices, to a second mode in which such configuration data will be distributed to client computing devices.

12. The method of claim 1, wherein instructing a specific user to operate the user's client computing device to cause transmission of the configuration settings to the user's client device comprises providing instructions to perform at least one of: closing and restarting the application, and moving the application into a background of an operating system environment and then subsequently moving the application into a foreground of the operating system environment.

13. The method of claim 1, wherein disclosing to the user the predefined user input required to cause the software application resident at the client device to enter the defined operational mode comprises disclosing an instruction to navigate to a predetermined user interface screen of the software application before providing the predefined user input.

14. The method of claim 1, wherein receiving information from the user's client device after the application has entered the defined operational mode comprises receiving logged data gathered at the client computing device.

15. A back-end server system for selectively permitting entry into a limited-access defined operational mode by distributed client-side software applications, the system comprising:
a processor;
a memory operably connected to the processor for storing the instructions; and
instructions stored in the memory to cause the system to:
selectively distribute, in response to user input, configuration settings on a limited basis, the configuration settings configuring a software application to enter a defined operational mode in response to receipt of predefined user input only after receipt of configuration settings from a back-end server, the configuration settings;
transmit, in response to a request from a user's client computing device, the configuration settings to the user's client device via a communications network to configure the user's client device to recognize the predefined user input; and
receive information from the user's client device after the application has entered the defined operational mode in response to the user's input of the predefined user input at the user's client device.

16. The back-end server system of claim 15, wherein the instructions are configured to cause the system to selectively distribute the configuration settings only for a limited, pre-defined period of time that is substantially less than a product distribution period for the software application.

17. The back-end server system of claim 15, wherein the instructions are configured to cause the system to selectively distribute the configuration settings as a function of a geographic location of a requesting device.

18. The back-end server system of claim 15, wherein the instructions are configured to cause the system to selectively distribute the configuration settings as a function of an IP address of a requesting device.

19. A computing device for selectively permitting entry into a limited-access defined operational mode, the system comprising:
a processor;
an input device for receiving user input;
a memory operably connected to the processor for storing the instructions; and
a software application stored in the memory and comprising instructions for causing the system to provide primary application functionality, the software application further comprising instructions to cause the computing device to provide access to a defined operational mode only after receipt of configuration settings from a back-end server, the configuration settings configuring the application to enter the defined operational mode in response to receipt of predefined user input via the input device.

20. A computing device of claim 19, further comprising:
a display device; and
instructions stored in the memory for causing the computing device to display via the display device a visual indicator confirming receipt of the predefined input in response to receipt of the predefined user input via the input device.

21. An application server for distributing a software application selectively permitting entry into a limited-access defined operational mode, the system comprising:
a processor;
a memory operably connected to the processor; and
a software application stored in the memory and comprising instructions for causing a computing device to provide primary application functionality, the software application further comprising instructions for causing the computing device to provide a defined operational mode to which access is limited, the software application further comprising instructions to cause the computing device to provide access to the defined operational mode only after receipt of configuration settings via a communications network, the configuration settings configuring the application to enter the defined operational mode in response to receipt of predefined user input via the computing device.

22. A tangible computer-readable medium storing a software application comprising a first instruction set for causing a computing device to provide primary application functionality, and a second instruction for causing the computing device to provide access to a defined operational mode of the software application only after receipt of configuration settings via a communications network, the configuration settings configuring the software application to enter the defined operational mode in response to receipt of predefined user input via the computing device.
